(19) United States
(12) Patent Application Publication
(10) Pub. No.: US 2024/0332870 A1
(43) Pub. Date: Oct. 3, 2024

(54) CONNECTOR, CONNECTOR SYSTEM AND TRANSMISSION METHOD

(71) Applicant: MD Elektronik GmbH, Waldkraiburg (DE)

(72) Inventors: Christoph ZAUNER, Braunau Ranshofen (AT); Marijela BAJIC, Waldkraiburg (DE); Michael DOERNDL, Heldenstein (DE)

(21) Appl. No.: 18/602,203

(22) Filed: Mar. 12, 2024

(30) Foreign Application Priority Data
Mar. 30, 2023 (DE) 10 2023 108 134.9

(51) Int. Cl. H01R 13/6593; H01R 9/05; H01R 13/502

(52) U.S. Cl. CPC H01R 13/6593; H01R 9/0503; H01R 9/0515; H01R 13/502

(57) ABSTRACT

A connector includes at least two separate inner conductor contacts and at least two separate outer conductor contacts, each surrounding a respective inner conductor contact of the inner conductor contacts and each being insulated from the respective inner conductor contact by an insulator. The connector further includes a holder configured to hold the outer conductor contacts and a shield housing, in which the holder, the outer conductor contacts, the insulators and the inner conductor contacts are arranged in an assembled state. The shield housing completely surrounds the outer conductor contacts along a line direction of the outer conductor contacts and serves as shielding.

### CROSS REFERENCE TO RELATED APPLICATIONS

This application claims benefit to German Patent Application No. DE 10 2023 108 134.9, filed on Mar. 30, 2023, which is hereby incorporated by reference herein.

### FIELD

The invention relates to a connector, in particular for a coaxial plug connection, a connector system and a transmission method, all of which are preferably suitable for a Power-over-Coax connection or transmission.

### BACKGROUND

Prior art connectors for coaxial plug connections are configured for a maximum transmission frequency of 15 GHz. The signal transmission is possible at 6 Gbit/s to 12 Gbit/s. These values are to be increased for future applications.

Furthermore, Power-over-Coax (PoC) refers to the current supply of a consumer via a connected coaxial plug connection. However, PoC can lead to problems with the electromagnetic compatibility (EMC), i.e. the consumer can interfere with other devices or be interfered with by them. These EMC problems can occur because in the case of POC the outer conductor acts as a current conductor and cannot be used for shielding. With PoC, data and power are split via the frequency and the current is transmitted via the inner conductor and outer conductor. In the prior art, a coaxial plug connection consisting of at least two coaxial lines can be used either as a differential coaxial connection or as a shielded twisted pair (STP) connection, but never as both.

DE 10 2021 103 224 A1 relates to a multi-pole coaxial connector. Thereby the outer conductors are held in a housing in such a way that they are electrically separated from each other, so that the outer conductors assigned to different inner conductors do not have to share a common electrical potential. Each of the outer conductors can therefore serve as individual shielding for the inner conductor it surrounds and can be connected separately from other outer conductors, for example to the printed circuit board, in order to be set to an individual electrical potential. For certain applications, the electrically separated from each other outer conductors can also be used to transmit electrical powers, whereby each outer conductor can be fed with current independently of adjacent outer conductors. However, the current feed of the outer conductors can lead to the EMC problems mentioned above.

In summary, this results in the problems in the prior art that RF connections above 15 GHz cannot be realized. The use of PoC is not practicable due to EMC problems. This is because the outer conductor of a coaxial plug connection is used as a current conductor (negative pole), which results in electromagnetic effects that can lead to increased radiation (corresponding to the EMC problem). Especially in safety-critical systems, such as in the automotive sector, EMC problems must be ruled out. In addition, PoC leads to a voltage drop at higher currents through the line. And finally, each connection technology used (STP or coaxial) requires a separate connector type.

### SUMMARY

In an embodiment, the present invention provides a connector. The connector includes at least two separate inner conductor contacts and at least two separate outer conductor contacts, each surrounding a respective inner conductor contact of the inner conductor contacts and each being insulated from the respective inner conductor contact by an insulator. The connector further includes a holder configured to hold the outer conductor contacts and a shield housing, in which the holder, the outer conductor contacts, the insulators and the inner conductor contacts are arranged in an assembled state. The shield housing completely surrounds the outer conductor contacts along a line direction of the outer conductor contacts and serves as shielding.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a perspective view of an embodiment of a connector;

FIG. 2 is a view of the connector from FIG. 1 as it can be connected to a printed circuit board;

FIG. 3 is an exploded view of the connector from FIG. 1;

FIGS. 4 to 6 are schematic illustrations of transmission methods for two coax lines with an additional common outer shield; and

FIG. 7 is a schematic illustration of an embodiment of a differential line.

### DETAILED DESCRIPTION

Embodiments of the present invention provide transmission options that enable higher frequencies and data transmission rates, are universally applicable and prevent the occurrence of EMC problems.

In particular, transmission options that enable higher frequencies and data transmission rates, are universally applicable and prevent the occurrence of EMC problems are achieved according to an embodiment of the present invention by a connector having at least two separate inner conductor contacts, at least two separate outer conductor contacts, which each surround an inner conductor contact and are each insulated from the respective inner conductor contact by an insulator, a holder for holding the at least two outer conductor contacts, a shield housing in which the holder, the outer conductor contacts, the insulators and the inner conductor contacts are arranged in the assembled state, the shield housing completely surrounding the outer conductor contacts along their direction of conduction and serving as a shielding.

In particular, the connector is configured for a Power-over-Coax connection using at least two shielded lines. The connector is preferably an automotive connector that can be attached to a PCB and/or cable side. The connector can be used to establish a connection with one to N coaxial conductors and an additional outer shield that acts over all 1 to N coaxial conductors. This additional outer shield improves the shielding effect and enables PoC without increased EMC radiation. Particularly with intermittent current consumption, unwanted peaks can occur, which can lead to an increased EMC radiation. This increased EMC radiation is intercepted by the present (additional) outer shield. With a double coaxial line, the use of both coaxial conductors for the supply can double the maximum current load and/or halve the voltage drop. The connector forms a universal plug-in system for coax, “differential coax” and differential lines. With the double-shielded coaxial conductors, an increase of the transmission rates can be achieved.

The line direction is the direction along which signals and/or current are conducted via the outer conductors. In the case of angled outer conductors, for example, the line direction can also be non-linear, or more precisely angled.

Preferably, the shield housing has a shielding that surrounds a contacting area of the outer conductor contacts. The shielding is electrically conductive and preferably firmly connected to the shield housing or formed in one piece with the shield housing. The shielding completely shields the outer conductor contacts on the connector side. In contrast to the prior art, the contacting area between the connector and mating connector in a plugged-in state is also (additionally) shielded, thus improving signal transmission. The fact that the shielding surrounds the contacting area of the outer conductor contacts means that the outer conductor contacts in the contacting area are completely surrounded by the shielding along a plug-in direction, whereby a plugging-in of the connector and mating connector is possible without hindrance.

Preferably, the shield housing, the outer conductor contacts as well as the inner conductor contacts are galvanically separated from each other. Due to the galvanic separation, one supply voltage per channel can be realized. Thus with two channels, two voltages can be applied and/or used.

The holder preferably distances the outer conductor contacts and insulates them from each other and from the shield housing. The insulation or separation comprises both a spatial and an electrical separation.

Transmission options that enable higher frequencies and data transmission rates, are universally applicable and prevent the occurrence of EMC problems are furthermore achieved according to another embodiment of the present invention by a connector system comprising a connector and a complementary mating connector.

Transmission options that enable higher frequencies and data transmission rates, are universally applicable and prevent the occurrence of EMC problems are further achieved according to a further embodiment of the present invention by a transmission method, in particular for a Power-over-Coax transmission, by means of at least two shielded lines and at least one common connector, the method comprising the following steps: bidirectional transmission of data and/or current via one or more of the at least two shielded lines, or unidirectional transmission of data and/or current via one or more of the at least two shielded lines, wherein each of the at least two shielded lines transmits separately, or bidirectional differential transmission of data and/or current via the at least two shielded lines, wherein, for transmission, at least two different supply voltages can be introduced at the at least two shielded lines.

By an expansion of the coaxial connector system with an additional outer shield, the range of applications can be massively expanded. This results in a multitude of possible transmission methods.

Using two coaxial data paths results in the fact that two separate channels can be used either bidirectionally at the same time or also unidirectionally. In the bidirectional use, both signals (i.e. in both signal directions) can be transmitted at up to twice the data than in the prior art (mentioned at the beginning). In the unidirectional use, a control channel can be separated from the data channel. The control channel can then be operated at the full bandwidth and/or data rate according to the prior art and send commands. The data channel can also use the full bandwidth and thus be operated at a higher data rate than in the prior art. The high-frequency signal transmission can be realized within the connector and a cable.

It is also possible, as up to now, to realize two individual coaxial lines, e.g. as a star point for two consumers.

Furthermore, bidirectional differential data transmission with two coaxial lines can now be realized for the first time. The individual cables or lines (pos. and neg.) are shielded from each other with the coaxial shields. The shielding can increase the data quality and enable a higher data rate. In particular, the use of a coaxial connection instead of an STP connection results in an increase. When expanding to four channels, the full data rate can be utilized again, i.e. two signal directions up to twice the data rate than in the prior art. In particular, this means two times the TX line and two times the RX line, and the differential signal in each case.

In addition, it would still be possible to connect a classic, in particular shielded, metered product for differential data transmission with an appropriate mating connector.

With optional differential data transmission in coaxial lines, signals can be transmitted at up to twice the data rate than in the prior art. In the case of optional differential data transmission with differential lines, signals can be transmitted at up to a single data rate than in the prior art.

In the application, with the present connector, connector system and/or transmission method a communication is enabled between high-performance ECUs in a motor vehicle with zone architecture at more than 25 Gbit/s, e.g. IEEE 802.3cy. Furthermore, Power-over-Coax transmission with fewer EMC problems is possible in a vehicle. Due to the insulated shields of the connector, a user can freely decide on the PCB, which ground topology is best suited for his design. And the transmission is possible for coax, “differential coax” and differential lines.

For a PoC application, the positive pole of the supply voltage can be applied via the inner conductor and the negative pole of the supply voltage via the outer conductor. In addition, the signal can be transmitted on the inner conductor, with the outer conductor representing the associated ground potential. The additional shield prevents the resulting interference peaks from being radiated outwards at the negative pole. If both coaxial channels are used, two different supply voltages can be introduced.

Preferably, the feature that at least two different supply voltages can be applied to the at least two shielded lines for transmission can be replaced by applying a supply voltage with twice the maximum current for transmission. If both coaxial channels are used, a supply voltage with double the maximum current can be introduced.

Preferably, the feature that at least two different supply voltages can be introduced to the at least two shielded lines for transmission can be replaced by introducing a supply voltage with a halved voltage drop for transmission. When using both coaxial channels, a supply voltage with halved voltage drop (double cross-section) can thus be introduced.

In the following, preferred embodiments are described in detail with reference to the included figures.

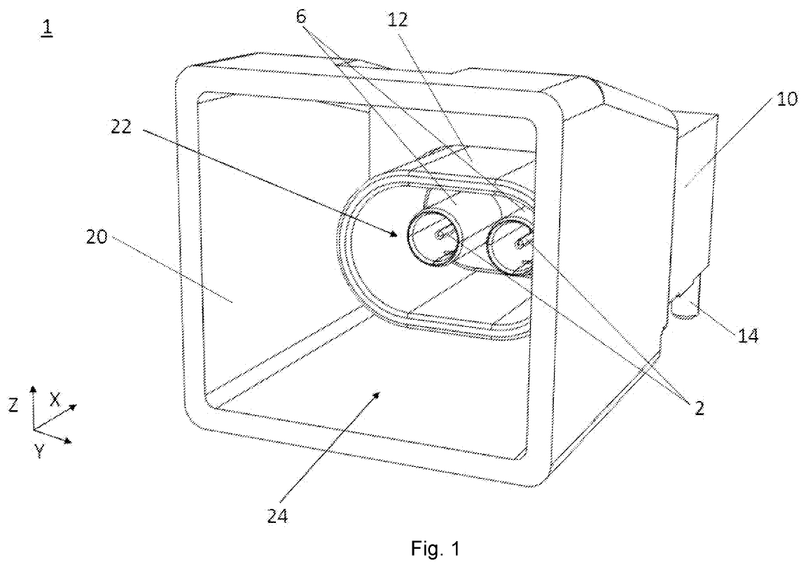

FIG. 1 shows an embodiment of a connector 1. In particular, FIG. 1 shows a PCB connector. The connector 1 has a coding housing 20 with a receiving opening 24 for accommodating a suitable mating connector. The coding housing 20 can be fastened to a shield housing 10 of the connector 1 via fastening means 28. In particular, the fastening means 28 can be configured as a latching opening and can be fastened at a complementary fastening means 18 on the shield housing 10. The coding housing 20 shown is configured with a so-called Z-coding, which can accommodate any coding on the mating connector. In an alternative embodiment, the coding housing 20 can be provided with a specific coding so that only certain mating connectors can be plugged to the connector 1. For mating, a mating connector is inserted into the receiving opening 24. The contacting area 22 of the connector 1 is arranged in the receiving opening 24. In the embodiment shown, the contacting area 22 has two plug-in positions, each with an outer and an inner conductor contact 6, 2. In alternative embodiments, a different number of plug-in positions may be present, for example in the case of a 4-pole connector four outer and four inner conductor contacts 6, 2.

The plug-in positions are surrounded by a shielding 12. The shielding 12 does not prevent the complementary outer and inner conductors 6, 2 from contacting the connector and the mating connector, but does shield the outer conductor contacts 6 completely. In particular, the shielding 12 can extend longer than the outer conductor contacts 6 in order to ensure a reliable shielding.

The shielding 12 is part of the shield housing 10. The shielding 12 can be configured in one piece with the shield housing 10. The shielding 12 is electrically conductive and is connected to ground together with the shield housing in order to serve as a shielding. The shield housing 10 can have protrusions 14. Via the protrusions 14, the shield housing 10 can be attached to a PCB or printed circuit board and can be contacted. The protrusions 14 serve as a ground connection. In addition to fastening via the protrusions 14, the shield housing 10 can be fastened to the PCB via further fastening means, for example by soldering.

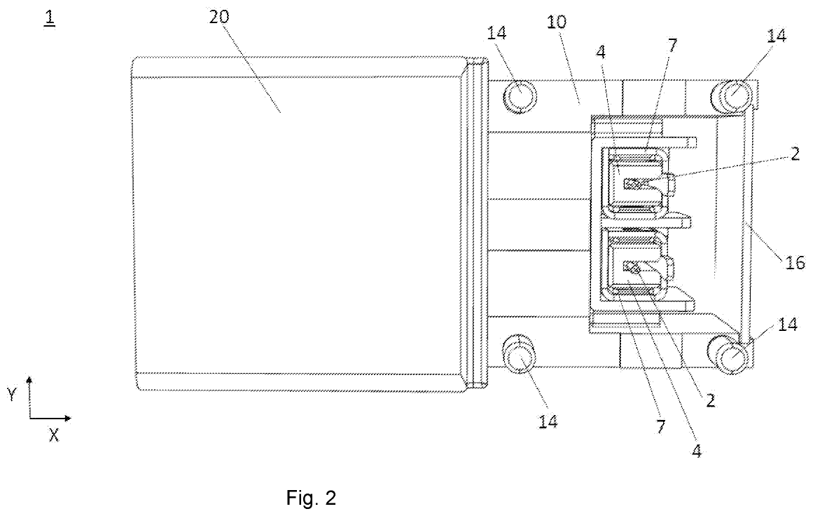

The ground connection of the shield housing 10 is separated, in particular galvanically separated, from the ground connections of the outer conductor contacts 6 and/or inner conductor contacts 2. FIG. 2 shows a view of the connector 1 as it can be connected to a printed circuit board. In FIG. 2 it can be seen that the electrical connections of the shield housing 10, outer conductor contacts 6 and inner conductor contacts 2 are spatially separated from each other. The outer conductor contacts 6 can thereby be connected to the printed circuit board via extensions 7. The outer conductor contacts 6 and the inner conductor contacts 2 can additionally be spatially and electrically separated and/or insulated from each other by the insulators 4. The separate grounds allow users to decide for themselves where to place ground points. This allows the ground topology to be configured in the best possible way for the application case.

In the automotive sector, there are standards for permissible EMC radiation. The present connector 1 reduces a radiation through the shield housing 10, the shielding 12 and the cover 16 so that it is within the standard range. Higher currents cause stronger EMC radiation. In the present connector, the shield housing 10, the shielding 12 and the cover 16 can reduce the radiation so that higher currents can also be transmitted.

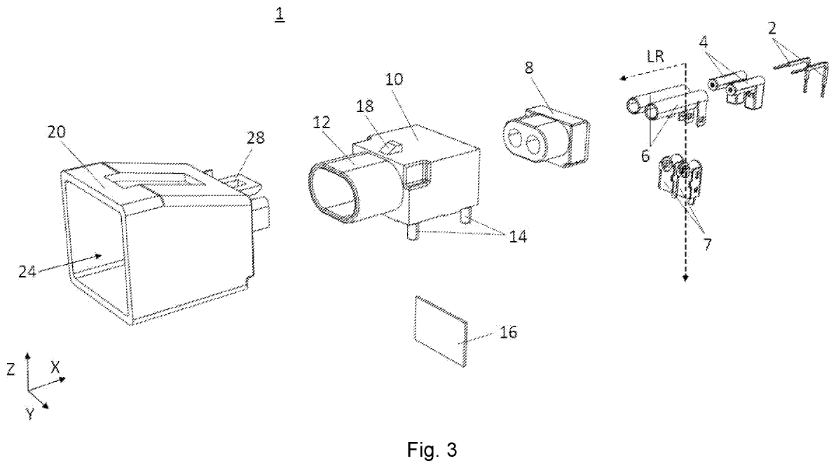

FIG. 3 shows the internal construction of an embodiment of the connector 1. When assembling the connector 1, the inner conductor contacts 2 are inserted into the respective insulators 4. The insulators 4 are in turn inserted into the respective outer conductor contacts 6. The outer conductor contacts 6 can be connected to extensions 7. Because of the extensions 7, the manufacture of the outer conductor contacts 6 as stamped and bent parts can be simplified, as no angling is necessary. In the embodiment shown, the angled conductor direction LR of the outer conductor contacts 6 is achieved by connecting the outer conductor contacts 6 with the extensions 7. In the case of a non-angled connector 1, the extensions 7 may under certain circumstances not be required and the conductor direction LR is linear and/or straight. The construction of inner conductor contacts 2, insulators 4 and outer conductor contacts 6 can then be guided into a holder 8. The holder 8 is made of a non-conductive material and holds the outer conductor contacts 6 at a distance from each other. The holder 8 can then be inserted into the shield housing 10 together with the construction just described. The holder 8 can, for example, be held in the shield housing 10 by latching. Finally, a cover 16 can be attached to the shield housing 10 in order to protect and electrically shield the holder 8 together with the contacts 2, 6.

FIGS. 1-3 show an embodiment of a printed circuit board connector 1. The connector 1 can alternatively be configured as a mating connector on the cable outlet side. The interface can be male or female. Alternatively, the connector system can comprise two cable connectors, straight and/or angled.

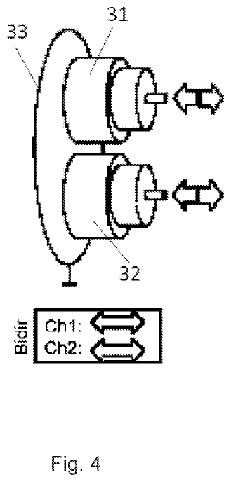

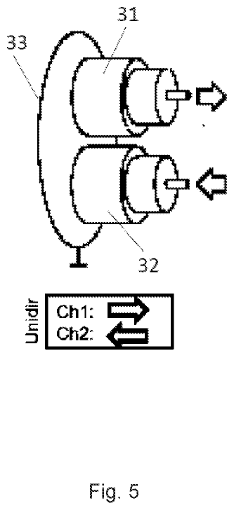

FIG. 4 shows two coaxial lines 31, 32 that are again shielded by an outer shield 33 such as the shield housing 10. The two coaxial lines 31, 32 can be operated in bidirectional mode and can enable a bidirectional data and/or current flow. In another embodiment, the two coaxial lines 31, 32 can also be operated in unidirectional mode (see FIG. 5). In this case, a TX or RX line can be used. In the unidirectional mode, each coaxial or shielded line 31, 32 transmits the data and/or current flow separately.

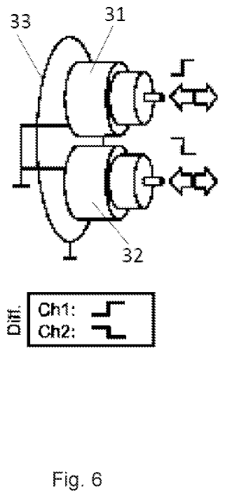

FIG. 6 shows a differential transmission mode, in which a bidirectional differential transmission of data and/or current takes place via the at least two shielded lines 31, 32. The shieldings of the two coaxial lines 31, 32 form a first shielding, and the outer shielding 33, such as the shield housing 10, forms a second shielding.

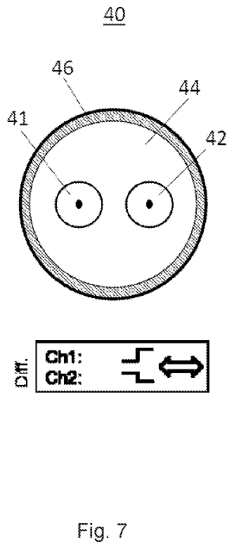

FIG. 7 shows a cross-section of an embodiment of a differential line 40, such as shielded twisted pair (STP). A differential mode is used for data and/or current transmission via the first and second lines 41, 42. Both lines 41, 42 are surrounded by an insulation layer 44. The shielding 46 of the differential line 40 can be connected with the shielding 12 of the connector 1, whereby the outer shielding of the first and second lines 41, 42 is continued uninterrupted also within the connector 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1 connector
2 inner conductor contacts
4 insulators
6 outer conductor contacts
7 extensions
8 holder
10 shield housing
12 shielding
14 protrusions
16 cover
18 fastening means
20 coding housing
22 contacting area
24 receiving opening
28 fastening means
31,32 shielded lines
33 outer shield
40 differential line
41 first line
42 second line
44 insulation
46 shielding
LR line direction
X first direction (plug-in direction)
Y second direction
Z third direction

What is claimed is:

1. A connector, comprising:
at least two separate inner conductor contacts;
at least two separate outer conductor contacts, each surrounding a respective inner conductor contact of the inner conductor contacts and each being insulated from the respective inner conductor contact by an insulator;
a holder configured to hold the outer conductor contacts; and
a shield housing, in which the holder, the outer conductor contacts, the insulators and the inner conductor contacts are arranged in an assembled state;
wherein the shield housing completely surrounds the outer conductor contacts along a line direction of the outer conductor contacts and serves as shielding.

2. The connector according to claim 1, wherein the shield housing has a shielding surrounding a contacting area of the outer conductor contacts.

3. The connector according to claim 1, wherein the shield housing, the outer conductor contacts and the inner conductor contacts are galvanically separated from one another.

4. The connector according to claim 1, wherein the holder distances the outer conductor contacts and insulates the outer conductor contacts from each other and from the shield housing.

5. A connector system comprising the connector according to claim 1 and a complementary mating connector.

6. A transmission method for a Power-over-Coax transmission by at least two shielded lines and at least one common connector comprising the connector according to claim 1, the method comprising:
bidirectional transmission of data and/or current via one or more of the at least two shielded lines; or
unidirectional transmission of data and/or current via one or more of the at least two shielded lines, wherein each of the at least two shielded lines transmits separately; or
bidirectional differential transmission of data and/or power via the at least two shielded lines,
wherein, for transmission purposes, at least two different supply voltages, a supply voltage with twice the maximum current or a supply voltage with a halved voltage drop can be introduced to the at least two shielded lines.

7. The transmission method according to claim 6, wherein the at least two different supply voltages are introduced for transmission.

8. The transmission method according to claim 6, wherein the supply voltage with twice the maximum current is introduced for transmission.

9. The transmission method according to claim 6, wherein the supply voltage with the halved voltage drop is introduced for transmission.
